(19) United States
(12) Patent Application Publication
(10) Pub. No.: US 2010/0156966 A1
(43) Pub. Date: Jun. 24, 2010

(54) IMAGE DISPLAY DEVICE

(76) Inventors: Hiroshi KAGEYAMA, Hachioji (JP); Tohru Kohno, Koganei (JP); Takahide Kuranaga, Tachikawa (JP); Hajime Akimoto, Kokubunji (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/637,826

(22) Filed: Dec. 15, 2009

(30) Foreign Application Priority Data
Dec. 18, 2008 (JP) 2008-322364

(51) Int. Cl. G09G 5/10

(52) U.S. Cl. 345/691; 345/77

(57) ABSTRACT

An image display device includes a first drive mode and a second drive mode. When N indicates an integer equal to or larger than 2(N≧2), a first to N-th frames are N successive frames, and j indicates an integer equal to or larger than 1. During a write period for a k-th (1≦k≦N) frame in the first drive mode, a scanning circuit sequentially selects a (k+N(j−1))-th display line, and a drive circuit supplies analog video voltages for the (k+N (j−1))-th display line to a plurality of signal lines. During a write period for all frames in the second drive mode, the scanning circuit sequentially selects all display lines, and the drive circuit supplies the analog video voltages for all the display lines to the plurality of signal lines.

### CROSS-REFERENCE TO RELATED APPLICATION

The present application claims priority from Japanese Application JP2008-322364 filed on Dec. 18, 2008, the content of which is hereby incorporated by reference into this application.

### BACKGROUND OF THE INVENTION

1. Field of the Invention

The present invention relates to an image display device, and, more particularly, to an active matrix type image display device using an organic electroluminescence element as a light-emitting element.

2. Description of the Related Art

An active-matrix-driven organic electroluminescence display (hereinafter, referred to as an organic EL display) using an organic electroluminescence element (hereinafter, referred to as an organic EL element) as a light-emitting element has been expected as a next-generation flat panel display.

In the active matrix type organic EL display, wirings for transferring video voltages or currents are arranged in matrix, and each pixel includes the organic EL element and a pixel circuit formed of thin film transistors (hereinafter, referred to as TFTs) which are active elements. A light emission luminance of the organic EL element is adjusted based on a current supplied from the pixel circuit to the organic EL element.

Known examples of the pixel circuit of the organic EL display are a capacitor-coupled pixel circuit in which a capacitor element for holding a video voltage is connected to a signal line (see, for example, JP 2003-122301 A) and a capacitor-separated pixel circuit in which a capacitor element is separated from a signal line by a switching transistor (see, for example, JP 2008-040326 A).

### SUMMARY OF THE INVENTION

The capacitor-coupled pixel circuit has a merit that the number of TFTs is normally small and the pixel circuit may be made more compact because the switch element between the signal line and the capacitor element is unnecessary. However, as illustrated in FIG. 9 of JP 2003-122301 A, each frame period is divided into a write period for writing the video voltage and a light emission (turn-on) period for displaying an image.

Thus, the light emission period of the capacitor-coupled pixel circuit is shorter than a frame period by a period for the write period, and, hence, there is a problem that a display luminance is dark compared with the capacitor-separated pixel circuit.

The present invention has been made in order to solve the above-mentioned problem of the conventional technology described above. It is therefore an object of the present invention to provide an image display device capable of switching between a normal display luminance mode and a high-luminance display mode for displaying an image with a luminance higher than a conventional luminance.

The above-mentioned and other objects and novel features of the present invention may become apparent from the description of this specification and the accompanying drawings.

One or more aspects of the invention disclosed in this application are generally and briefly described as follows. (1) An image display device includes a plurality of pixels, a plurality of signal lines configured to input video voltages to the plurality of pixels, a plurality of control lines configured to input scanning voltages to the plurality of pixels, a drive circuit configured to supply analog video voltages to the plurality of signal lines, and a scanning circuit configured to supply the scanning voltages to the plurality of control lines. Each of the plurality of pixels includes a light-emitting element, a drive transistor configured to drive the light-emitting element, and a capacitor element connected between a gate electrode of the drive transistor and one of the plurality of signal lines. The image display device has a first drive mode and a second drive mode. Each one frame period includes a write period for supplying the video voltages to the plurality of pixels through the plurality of signal lines and a light emission period for emitting light using the light-emitting elements based on the video voltages supplied to the plurality of pixels. N indicates an integer equal to or larger than 2 (N≧2), the first to N-th frames are N successive frames, and j indicates an integer equal to or larger than 1. During a write period for a k-th (1≦k≦N) frame in the first drive mode, the scanning circuit sequentially selects a (k+N(j−1))-th display line, and the drive circuit supplies the analog video voltages for the (k+N(j−1))-th display line to the plurality of signal lines. During a write period for all frames in the second drive mode, the scanning circuit sequentially selects all display lines, and the drive circuit supplies the analog video voltages for all the display lines to the plurality of signal lines.

(2) In the image display device according to Item (1), N is equal to 2. In the first drive mode, during the write period for the first frame, the scanning circuit sequentially selects odd-numbered display lines, the drive circuit supplies the analog video voltages for the odd-numbered display lines to the plurality of signal lines, and during the write period for the second frame, the scanning circuit sequentially selects even-numbered display lines and the drive circuit supplies the analog video voltages for the even-numbered display lines to the plurality of signal lines. In the second drive mode, during the write period for all the frames, the scanning circuit sequentially selects all the display lines, and the drive circuit supplies the analog video voltages for all the display lines to the plurality of signal lines. (3) In the image display device according to Item (1) or (2), the image display device according to claim 1, each of the plurality of pixels further includes a switching transistor that is connected between a gate electrode and a drain electrode of the drive transistor. A gate electrode of the switching transistor is connected to one of the plurality of control lines.

(4) The image display device according to Item (3) further includes a plurality of turn-on control lines for inputting scanning voltages to the plurality of pixels. Each of the plurality of pixels further includes a turn-on transistor. One of a source electrode and a drain electrode of the turn-on transistor is connected to the drain electrode of the drive transistor. The other one of the source electrode and the drain electrode of the turn-on transistor is connected to one end of the light-emitting element. The gate electrode of the turn-on transistor is connected to one of the plurality of turn-on control lines. (5) In the image display device according to Item (1) or (2), during the light emission period in each of the first drive mode and the second drive mode, the drive circuit supplies a reference voltage to the plurality of signal lines. A light emission time of the light-emitting element of each of the plurality of pixels during the light emission period in the first drive mode is longer than a light emission time of the light-emitting element of each of the plurality of pixels during the light emission period in the second drive mode. (6) In the image display device according to Item (1) or (2), the light emission period in the first drive mode and the light emission period in the second drive mode are adjustable. (7) In the image display device according to Item (2), when a clock supplied to the scanning circuit in the second drive mode is clock F, the clock supplied to the scanning circuit in the first drive mode is a clock obtained by combining the clock-F and a clock-. The clock-f is equal in frequency to and different in phase from the clock-F.

An effect obtained by the typical aspect of the invention disclosed in this application is briefly described as follows.

According to the image display device of the present invention, the switching between the normal display luminance mode and the high-luminance display mode for displaying the image with the luminance higher than the conventional luminance may be achieved.

### BRIEF DESCRIPTION OF THE DRAWINGS

FIG. 1 is a block diagram illustrating a schematic structure of an organic EL display panel of an image display device according to an embodiment of the present invention.

FIG. 2 is an explanatory diagram illustrating an operation for writing a video voltage into a pixel and a light emission operation of the pixel in the image display device according to the embodiment of the present invention.

FIG. 3 is a circuit diagram illustrating a circuit structure of a scanning circuit illustrated in FIG. 1.

FIG. 4 illustrates input waveforms and output waveforms of the scanning circuit during a write period in a normal mode of the organic EL display panel in the embodiment of the present invention.

FIG. 5 illustrates input waveforms and output waveforms of the scanning circuit during a write period in a high-luminance mode of the organic EL display panel in the embodiment of the present invention.

FIG. 6 illustrates normal mode operation waveforms of four pixels corresponding to a longitudinal line located at a left end, of a plurality of pixels illustrated in FIG. 1.

FIG. 7 illustrates high-luminance mode operation waveforms of the four pixels corresponding to the longitudinal line located at the left end, of the plurality of pixels illustrated in FIG. 1.

FIG. 8 is a block diagram illustrating a schematic structure of the image display device according to the embodiment of the present invention.

FIG. 9 is an explanatory diagram illustrating a modified example of the image display device according to the embodiment of the present invention.

FIG. 10 is an explanatory diagram illustrating a modified example of the image display device according to the embodiment of the present invention.

FIG. 11 illustrates a mobile electronic device to which the image display device according to the embodiment of the present invention is applied.

FIG. 12 illustrates a structure of a TV or video monitor to which the image display device according to the embodiment of the present invention is applied.

### DETAILED DESCRIPTION OF THE INVENTION

Hereinafter, an embodiment of the present invention is described in detail with reference to the attached drawings.

In the explanatory drawings for the embodiment, elements having the same functions are indicated by the same reference symbols and the duplicated description thereof is omitted.

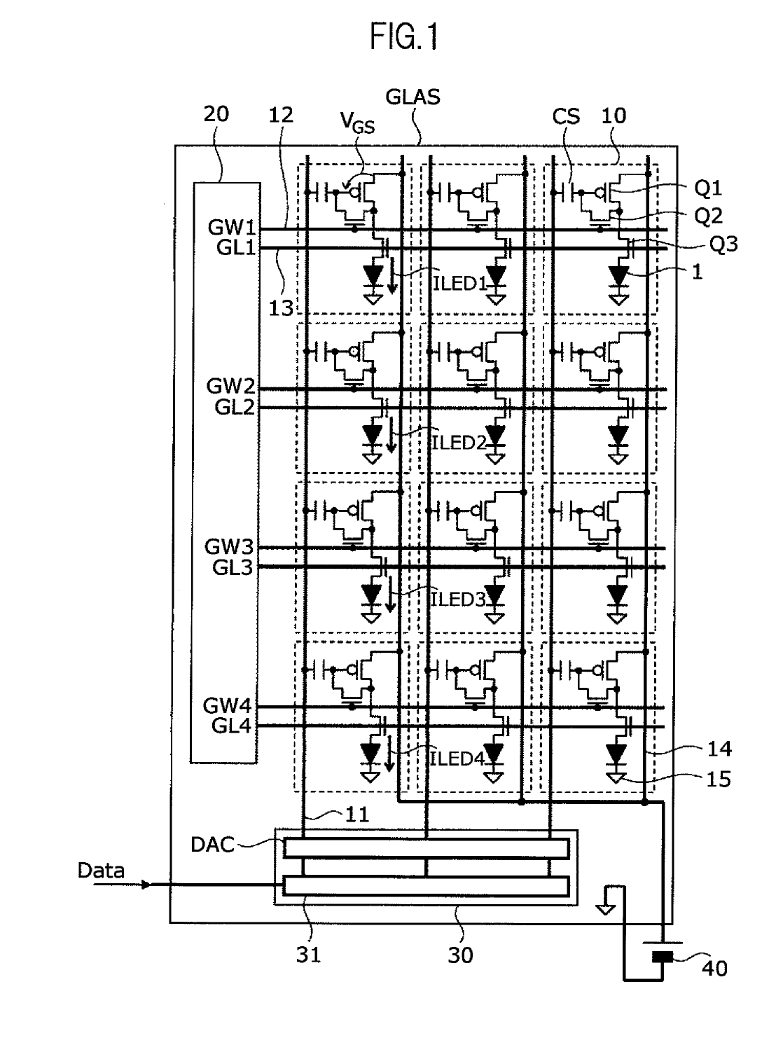

FIG. 1 is a block diagram illustrating a schematic structure of an organic EL display panel of an image display device according to the embodiment of the present invention.

As illustrated in FIG. 1, a plurality of pixels 10 are provided as a matrix in a display region of the organic EL display panel. The pixels 10 are connected to signal lines 11, write control lines 12, turn-on control lines 13, and power supply lines 14.

The write control lines 12 and the turn-on control lines 13 are connected to a scanning circuit 20. The scanning circuit 20 supplies driving voltages to the write control lines 12 and the turn-on control lines 13 in order to select display lines. The signal lines 11 are connected to a drive circuit 30. The drive circuit 30 includes a line memory 31 and a digital/analog converter DAC. The line memory 31 is used to perform serial/parallel conversion on digital video data “Data” that are serially supplied from an outside of the organic EL display panel. The digital/analog converter DAC converts parallel digital video data into an analog video voltage.

The respective circuits such as the pixels 10, the scanning circuit 20, and the drive circuit 30 are formed on a glass substrate GLAS using low-temperature polycrystalline silicon thin films that are generally well known. A large number of the pixels 10 are actually arranged in the display region of the organic EL display panel, but 12 pixels (=3 columns×4 rows) are illustrated in FIG. 1 for simplifying FIG. 1. For example, when a screen resolution is equal to a color VGA resolution, the number of pixel columns is 1,920 and the number of pixel rows is 480.

Common ground lines are provided for the pixels 10 but are omitted.

Each of the pixels 10 includes an organic electroluminescence element (hereinafter, referred to as an organic EL element) 1 serving as a light-emitting element. A cathode electrode of the organic EL element 1 is connected to a common electrode 15. An anode electrode of the organic EL element 1 is connected to the power supply line 14 through an n-type thin film transistor for turning-on (hereinafter, referred to as a turning-on TFT) Q3 and a p-type thin film transistor (hereinafter, referred to as a driving TFT) Q1.

A source electrode of the driving TFT Q1 is connected to the power supply line 14 that is common to all the pixels 10. A current required to emit light from the organic EL element 1 is supplied from an external power supply 40 to the power supply line 14 and the common electrode 15.

A gate electrode of the driving TFT Q1 is connected to any of the signal lines 11 through a capacitor element (holding capacitor) CS. An n-type thin film transistor for writing (hereinafter, referred to as a writing TFT) Q2 is provided between a drain electrode and the gate electrode of the driving TFT Q1. A gate electrode of the writing TFT Q2 is connected to any of the write control lines 12. A gate electrode of the turning-on TFT Q3 is connected to any of the turn-on control lines 13.

The driving TFT Q1, the writing TFT Q2, and the turning-on TFT Q3 are respectively provided on a glass substrate as a polycrystalline silicon thin film transistor that includes polysilicon in a semiconductor layer. A method of manufacturing the polycrystalline silicon thin film transistor or the organic EL element 1 is not significantly different from generally reported methods, and, hence, the description of the manufacturing method is omitted here.

In this embodiment, one frame period that is set to 1/60 seconds in advance is divided into a “write period” and a “light emission period”.

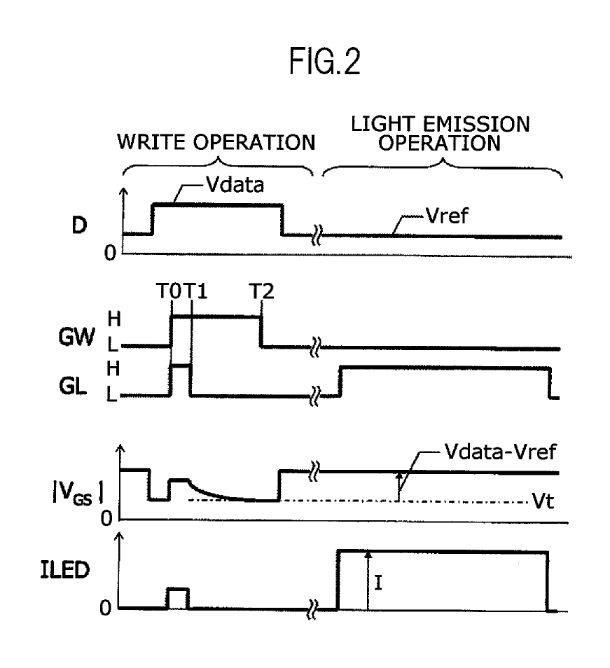

FIG. 2 is an explanatory diagram illustrating an operation for writing a video voltage into each of the pixels 10 and a light emission operation of each of the pixels 10.

In FIG. 2, reference symbol D indicates a video voltage supplied to one of the signal lines 11, reference symbol GW indicates a driving voltage supplied to one of the write control lines 12, and reference symbol GL indicates a driving voltage supplied to one of the turn-on control lines 13. Hereinafter, the “write period” and the “light emission period” are explained.

### [Write Period]

At the time of writing, an analog video voltage Vdata is supplied as the video voltage D from the drive circuit 30 to the signal line 11.

Next, when the driving voltage GW and the driving voltage GL become a High-level (hereinafter, referred to as a H-level) at a time T0, the writing TFT Q2 and the turning-on TFT Q3 are turned on. Then, the driving TFT Q1 becomes a diode connection state in which the gate electrode is connected to the drain electrode, and, hence, a voltage of the gate electrode of the driving TFT Q1, which is stored in the capacitor element CS in a preceding field, is cleared.

Next, when the driving voltage GL becomes a Low-level (hereinafter, referred to as an L-level) at a time T1, the turning-on TFT Q3 is turned off. Then, the driving TFT Q1 and the organic EL element 1 forcedly become a current off state. However, at this time, the gate electrode and the drain electrode of the driving TFT Q1 are short-circuited through the writing TFT Q2, and, hence, a voltage at the gate electrode of the driving TFT Q1 that corresponds to one of ends of the capacitor element CS is automatically reset to a voltage lower than a voltage on the power supply line 14 by a threshold voltage Vth of the driving TFT Q1.

Next, when the driving voltage GW becomes the L-level at a time T2, the writing TFT Q2 is turned off, and, hence, a potential difference between both ends of the capacitor element CS is stored in the capacitor element CS without any change.

That is, the threshold voltage Vth of the driving TFT Q1 or a voltage value Vt that is close to the threshold voltage Vth is generated as an absolute value of a gate-source voltage (|Vgs|) of the driving TFT Q1. Then, a voltage difference between the voltage Vt and the analog video voltage Vdata is stored in the capacitor element CS.

At this time, when a voltage value that is input to a signal line 11 side of the capacitor element CS is higher than the analog video voltage Vdata, the driving TFT Q1 becomes in an off state. On the other hand, when the voltage value input to the signal line 11 side of the capacitor element CS is lower than the analog video voltage Vdata, the driving TFT Q1 becomes in an on state.

In addition, While the pixels 10 located on a display line of another row are scanned, the turning-on TFT Q3 of the pixel 10 is continuously in the off state, and, hence, the organic EL element 1 is not turned on regardless of a level of the analog video voltage on the signal line 11.

The writing of the analog video voltage into each of the pixels is sequentially performed for each row as described above. After the writing into all the pixels is performed, the “write period” of one frame ends.

### [Light Emission Period]

During the “light emission period” in one frame period, the scanning circuit 20 is stopped so that the driving voltage GW becomes in the L-level, and the driving voltage GL becomes in the H-level. Therefore, the turning-on TFTs Q3 of all the pixels simultaneously become in the on state. At this time, a reference voltage Vref that is constant is input to the signal lines 11.

Here, the turning-on TFTs Q3 are continuously in the on state. Therefore, the organic EL element 1 of each of the pixels 10 is driven by the driving TFT Q1 based on a voltage relationship between the analog video voltage Vdata that is written in advance and the reference voltage Vref that is supplied to the signal lines 11.

When the driving TFT Q1 is driven in a saturation region, a current ILED flowing through the organic EL element 1 may be approximately expressed by “ILED=β(Vgs−Vt)²”. In addition, β indicates a gain factor of a thin film transistor.

Because the voltages on the signal lines 11 are held to have the reference voltage Vref that is a constant voltage, Vgs is expressed by Vgs=Vdata−Vref+Vt and ILED is expressed by ILED=β(Vdata−Vref)². Therefore, it is possible to flow a current I that is uniquely determined by the analog video voltage Vdata to the organic EL element 1.

In addition, during the light emission period, a triangular wave voltage may be used instead of the constant reference voltage Vref.

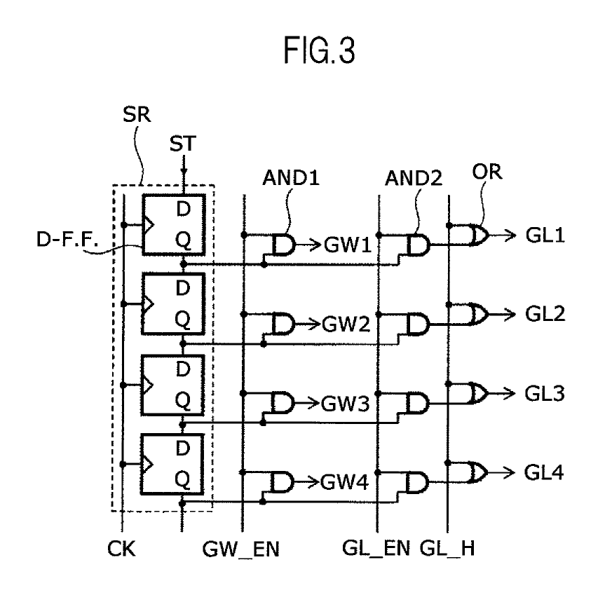

FIG. 3 is a circuit diagram illustrating a circuit structure of the scanning circuit 20 illustrated in FIG. 1.

The scanning circuit 20 includes a shift register circuit SR having a plurality of D-type flip-flop circuits D-F.F., AND circuits AND1 and AND2, and OR circuits OR.

A clock CK for synchronously operating the D-type flip-flop circuits D-F.F. is input to the shift register circuit SR.

A control signal GW_EN is used to determine a pulse width of driving voltages GW1 to GW4 that are supplied to the first to fourth write control lines 12. The driving voltages GW1 to GW4 are generated using AND operation of the control signal GW_EN and respective stage outputs of the shift register circuit SR in the AND circuits AND1.

A control signal GL_EN is used to determine a pulse width of driving voltages GL1 to GL4 that are supplied to the first to fourth turn-on control lines 13. The driving voltages GL1 to GL4 are generated using AND operation of the control signal GL_EN and respective stage outputs of the shift register circuit SR in the AND circuits AND2.

A control signal GL_H is used to set each of the driving voltages GL1 to GL4 to the H-level during the light emission period. The driving voltages GL1 to GL4 each having the H-level during the light emission period are generated using OR operation of the control signal GL_H and respective outputs of the AND circuits AND2 in the OR circuits OR.

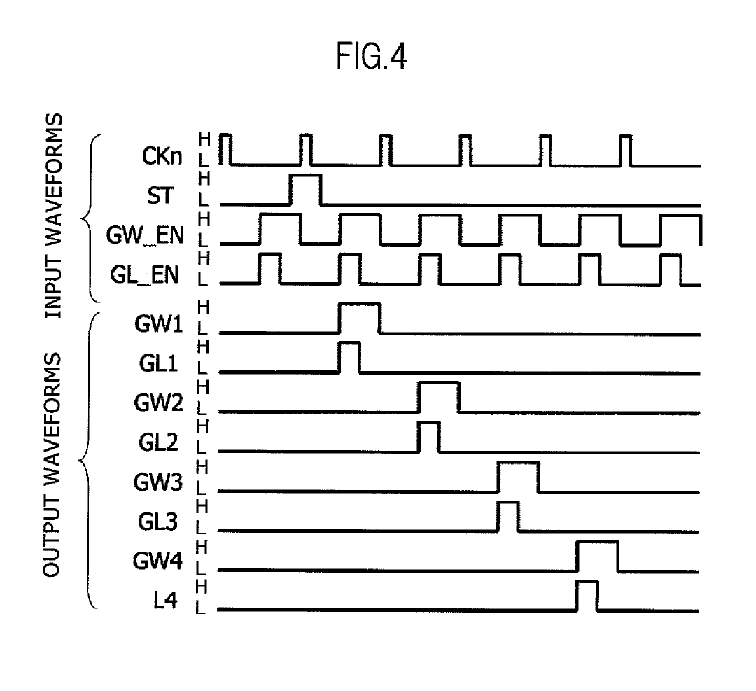

FIG. 4 illustrates input waveforms and output waveforms of the scanning circuit 20 during a write period in a normal mode of the organic EL display panel in this embodiment. The control signals GW_EN and GL_EH are input in synchronization with a clock CKn.

When a start signal ST is input to the shift register circuit SR, the shift register circuit SR starts to scan. Then, the driving voltages GW1 to GW 4 are output to the first to fourth write control lines 12 in synchronization with the clock CKn, and the driving voltages GL1 to CL 4 are output to the first to fourth turn-on control lines 13 in synchronization with the clock CKn.

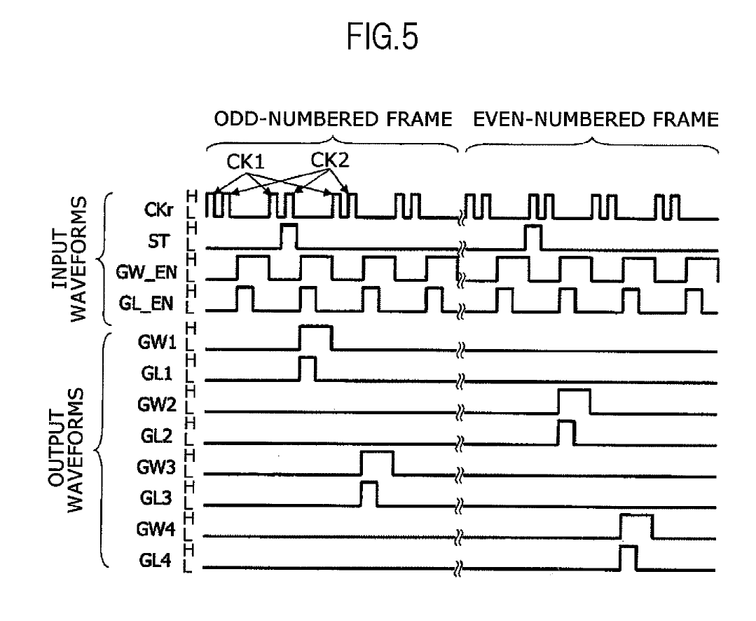

FIG. 5 illustrates input waveforms and output waveforms of the scanning circuit 20 during a write period in a high-luminance mode of the organic EL display panel in this embodiment.

In the case of the write period of the high-luminance mode, a clock CKr is obtained by combining clocks CK1 and CK2. The clocks CK1 and CK2 have the same frequency as the clock CKn in the case of the write period of the normal mode and are different in phase from each other.

The control signals GW_EN and GL_EN are input as signals having the same waveforms as in the case of the write period of the normal mode.

A timing for inputting the start signal ST in an odd-numbered frame is different from that in an even-numbered frame. In the odd-numbered frame, the start pulse ST is overlapped with the clock CK2 of the two clocks CK1 and CK2 so as to output the driving voltages only to the pixels 10 on odd-numbered display lines. Thus, the driving voltages GW1 and GW3 are output to the first and third write control lines 12 in synchronization with the clock CK2. The driving voltages GL1 and GL3 are output to the first and third turn-on control lines 13 in synchronization with the clock CK2.

In the even-numbered frame, the start pulse ST is overlapped with the clock CK1 of the two clocks CK1 and CK2 so as to output the driving voltages only to the pixels 10 on even-numbered display lines. The driving voltages GW2 and GW4 are output to the second and fourth write control lines 12 in synchronization with the clock CK1. The driving voltages GL2 and GL4 are output to the second and fourth turn-on control lines 13 in synchronization with the clock CK1.

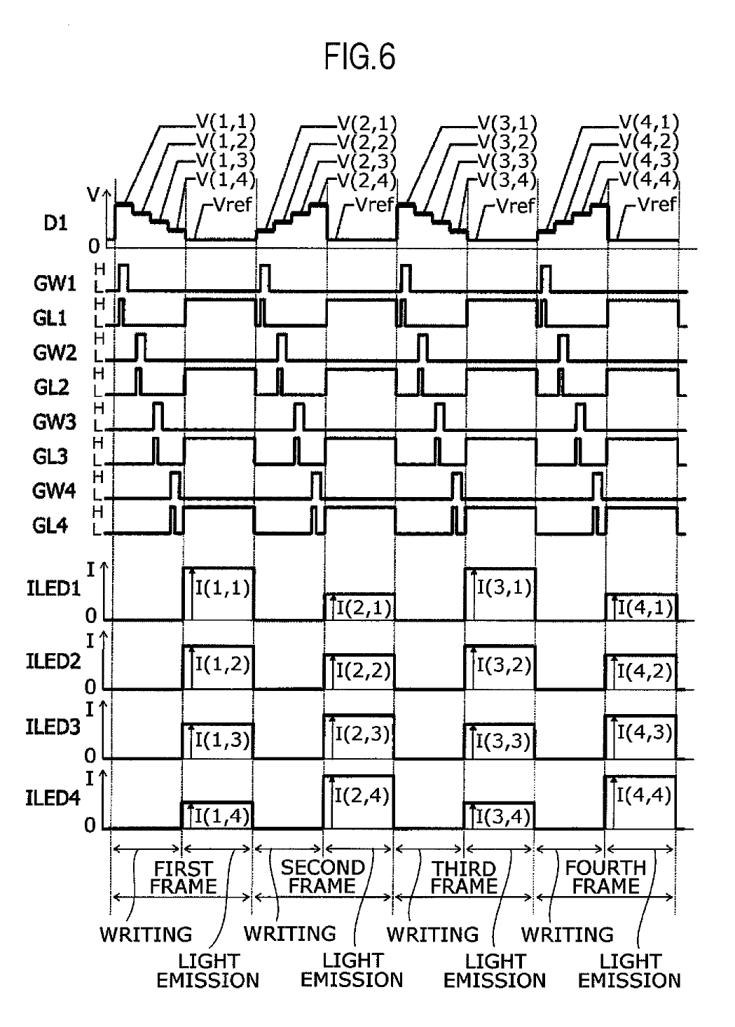

FIG. 6 illustrates normal mode operation waveforms of four pixels corresponding to a longitudinal line located at a left end of the plurality of pixels 10 illustrated in FIG. 1.

During the write period for the first frame (for example, odd-numbered frame), the analog video voltages V(1, 1) to V(1, 4) are successively supplied from the drive circuit 30 to the signal lines 11.

The driving voltages GW1 to GW4 illustrated in FIG. 6 are supplied to the first to fourth write control lines 12. The driving voltages GL1 to GL4 illustrated in FIG. 6 are supplied to the first to fourth turn-on control lines 13.

Therefore, the analog video voltages V(1, 1) to V(1, 4) are stored in the capacitor elements CS of the four pixels 10 corresponding to the longitudinal line, and, hence, currents I(1, 1) to I(1, 4) flowing through the organic EL elements 1 during the light emission period are specified.

After that, the same operation is performed for a second frame (for example, even-numbered frame) to a fourth frame.

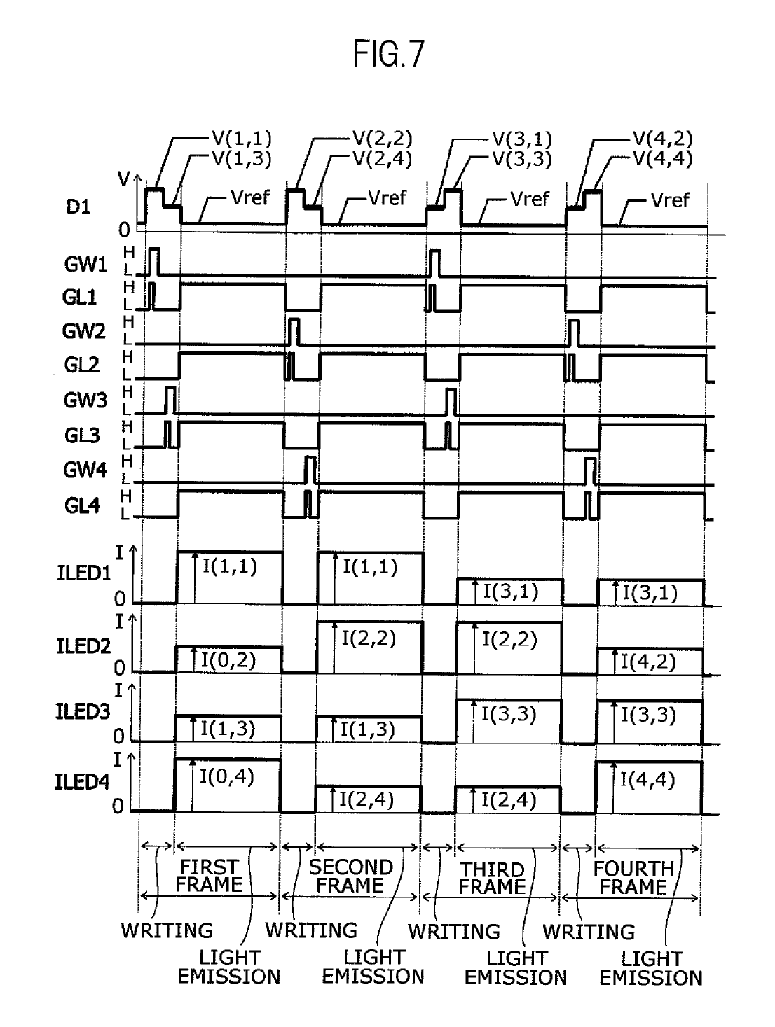

FIG. 7 illustrates high-luminance mode operation waveforms of the four pixels corresponding to the longitudinal line located at the left end, of the plurality of pixels 10 illustrated in FIG. 1.

During the write period for the first frame (for example, odd-numbered frame), the analog video voltages V(1, 1) and V(1, 3) to be written into the pixels 10 that are located on the odd-numbered display line are successively supplied from the drive circuit 30 to the signal lines 11.

The driving voltages GW1 to GW4 illustrated in FIG. 7 are supplied to the first to fourth write control lines 12. The driving voltages GL1 to GL4 for the odd-numbered frame which are illustrated in FIG. 7 are supplied to the first to fourth turn-on control lines 13.

Accordingly, the writing operation only for the pixels 10 on the odd-numbered display line is performed, and, hence, the write period is completed in half the period of the normal mode.

During the light emission period, only the currents I(1, 1) and I(1, 3) flowing through the organic EL elements 1 located on the odd-numbered display line are updated. Currents I(0, 2) and I(0, 4) flowing through the organic EL elements 1 located on the even-numbered display line are not updated (“0” indicates writing into frame preceding first frame).

During the write period for the second frame (for example, even-numbered frame), only the analog video voltages V(2, 2) and V(2, 4) to be written into the pixels 10 located on the even-numbered display line are successively supplied from the drive circuit 30 to the signal lines 11.

The driving voltages GW1 to GW4 illustrated in FIG. 7 are supplied to the first to fourth write control lines 12. The driving voltages GL1 to GL4 for the even-numbered frame which are illustrated in FIG. 7 are supplied to the first to fourth turn-on control lines 13.

Accordingly, the writing operation only for the pixels 10 on the even-numbered display line is performed, and, hence, the write period is completed in half the period of the normal mode.

During the light emission period, only the currents I(2, 2) and I(2, 4) flowing through the organic EL elements 1 located on the even-numbered display line are updated. Currents I(1, 1) and I(1, 3) flowing through the organic EL elements 1 located on the odd-numbered display line are not updated.

The same operation as for the first and second frames is performed for the third and fourth frames.

As described above, the write period in the high-luminance mode always becomes half of the write period in the normal mode by driving in the high-luminance mode as illustrated in FIG. 7. Thus, the light emission period in the high-luminance mode can be extended by the shortened time of the write period.

In compensation for this, a moving picture response becomes slower because the number of the write operations is reduced to perform rewriting the respective pixels 10 once every two frames. However, when the high-luminance mode described above is limitedly used for cases where very high-speed display is not performed, there is no problem.

Because the amount of current I is maintained to a predetermined amount between two frames by the voltages stored in the capacitor elements CS, a flicker does not occur.

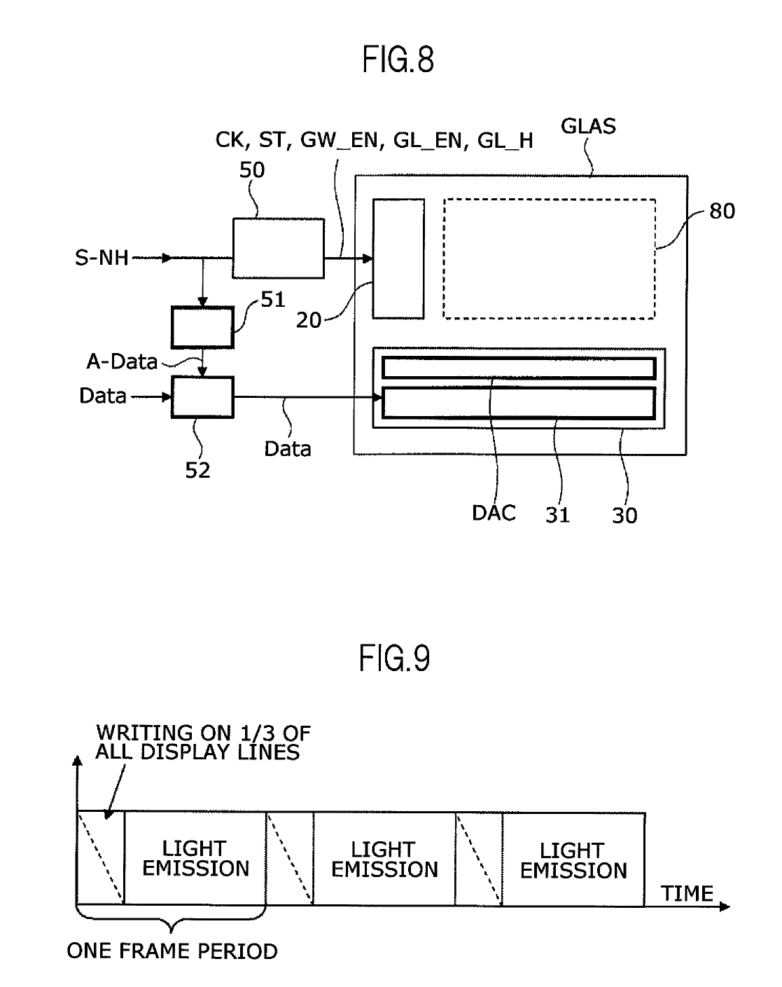

FIG. 8 is a block diagram illustrating a schematic structure of the image display device according to this embodiment. In FIG. 8, the pixels 10 are arranged as a matrix in a display region 80.

Video data “Data” supplied from an application device of the image display device is temporarily stored in a frame memory 52.

A normal-mode/high-luminance mode switch signal S-NH is received from the application device and supplied to a timing controller 50 and an address circuit 51.

The address circuit 51 outputs address data A-data to the frame memory 52 so as to successively read video data in the normal mode and to read only odd-numbered row (even-numbered row) video data at each odd-numbered frame (even-numbered frame) in the high-luminance mode.

The timing controller 50 generates the clocks CKn and CKr, the start signal ST, and the control signals GW_EN, GL_EN, and GL_H which are used for the scanning circuit 20 as described in FIGS. 4 and 5. The timing controller 50 generates the input waveforms illustrated in FIG. 4 in the normal mode and the input waveforms illustrated in FIG. 5 in the high-luminance mode.

As described above, the 1/2-display line writing is performed on each of the two successive frames. Alternatively, as illustrated in FIG. 9, 1/N-display line writing may be performed on each of N successive frames (three frames in FIG. 9). In this case, because the light emission period can be further extended, an image can be displayed at higher luminance.

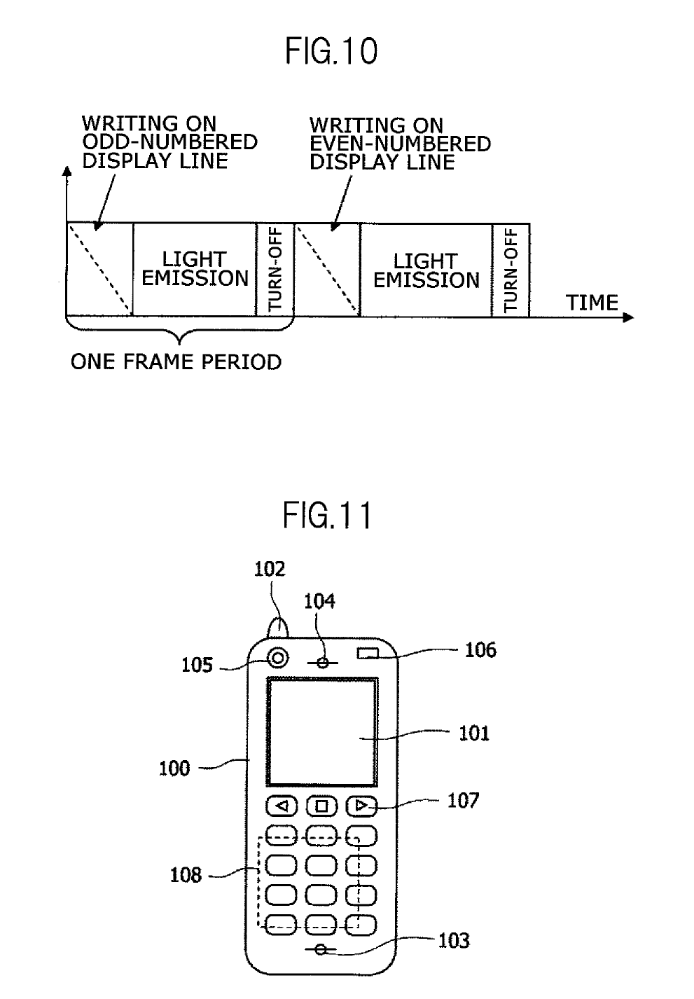

Further, as illustrated in FIG. 10, a “turn-off period” may be set after the “light emission period.” In a case of a driving method illustrated in FIG. 10, brightness can be adjusted.

FIG. 11 illustrates a mobile electronic device to which the image display device according to this embodiment is applied.

A mobile electronic device 100 includes, in addition to an image display device 101 according to this embodiment, an antenna 102, a microphone 103, a speaker 104, an image pickup element 105, an optical sensor 106, and an audio replay button 107. The mobile electronic device 100 further includes a battery 108 for supplying power.

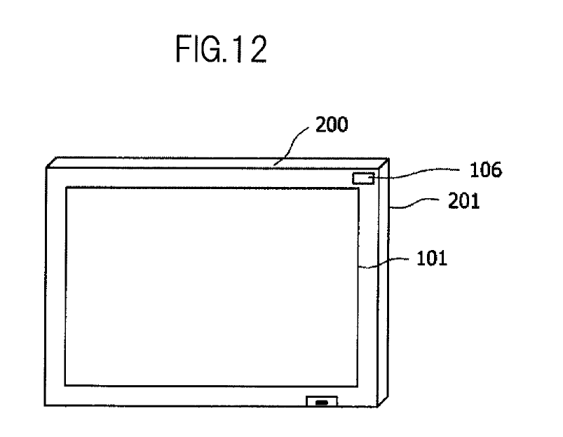

FIG. 12 illustrates a structure of a TV or video monitor to which the image display device according to this embodiment is applied.

The image display device 101 according to this embodiment is mounted in an inner portion of a frame 201 of a TV or video monitor 200. The optical sensor 106 is provided in a portion of the frame 201.

The image display device of this embodiment can increase, the display luminance in the high-luminance mode so as to improve the visibility of a display image displayed on the mobile electronic device 100 illustrated in FIG. 11 or the TV or video monitor 200 illustrated in FIG. 12.

By switching the normal mode and the high-luminance mode based on ambient brightness detected by the optical sensor 106, adjust the display luminance can be adjusted so that the visibility of a display video image may be improved according to a change in ambient luminous intensity.

While there have been described what are at present considered to be certain embodiments of the invention, it will be understood that various modifications may be made thereto, and it is intended that the appended claim cover all such modifications as fall within the true spirit and scope of the invention.

What is claimed is:

1. An image display device comprising:
a plurality of pixels;
a plurality of signal lines configured to input video voltages to the plurality of pixels;
a plurality of control lines configured to input scanning voltages to the plurality of pixels;
a drive circuit configured to supply analog video voltages to the plurality of signal lines; and
a scanning circuit configured to supply the scanning voltages to the plurality of control lines,
wherein each of the plurality of pixels includes:
a light-emitting element;
a drive transistor configured to drive the light-emitting element; and
a capacitor element connected between a gate electrode of the drive transistor and one of the plurality of signal lines,
wherein the image display device has a first drive mode and a second drive mode,
wherein each one frame period includes:
a write period for supplying the video voltages to the plurality of pixels through the plurality of signal lines; and
a light emission period for emitting light using the light-emitting elements based on the video voltages supplied to the plurality of pixels, and
wherein when N indicates an integer equal to or larger than 2(N≧2), the first to N-th frames are N successive frames, and j indicates an integer equal to or larger than 1,
during a write period for a k-th (1≦k≦N) frame in the first drive mode, the scanning circuit sequentially selects a (k+N (j−1))-th display line, and the drive circuit supplies the analog video voltages for the (k+N(j−1))-th display line to the plurality of signal lines, and
during a write period for all frames in the second drive mode, the scanning circuit sequentially selects all display lines, and the drive circuit supplies the analog video voltages for all the display lines to the plurality of signal lines.

2. The image display device according to claim 1,
wherein N is equal to 2,
wherein in the first drive mode, during the write period for the first frame, the scanning circuit sequentially selects odd-numbered display lines,
the drive circuit supplies the analog video voltages for the odd-numbered display lines to the plurality of signal lines, and
during the write period for the second frame, the scanning circuit sequentially selects even-numbered display lines and the drive circuit supplies the analog video voltages for the even-numbered display lines to the plurality of signal lines, and
wherein in the second drive mode, during the write period for all the frames, the scanning circuit sequentially selects all the display lines, and
the drive circuit supplies the analog video voltages for all the display lines to the plurality of signal lines.

3. The image display device according to claim 1,
wherein each of the plurality of pixels further comprises a switching transistor that is connected between a gate electrode and a drain electrode of the drive transistor, and
wherein a gate electrode of the switching transistor is connected to one of the plurality of control lines.

4. The image display device according to claim 3 further comprising a plurality of turn-on control lines for inputting scanning voltages to the plurality of pixels,
wherein each of the plurality of pixels further comprises a turn-on transistor,
wherein one of a source electrode and a drain electrode of the turn-on transistor is connected to the drain electrode of the drive transistor,
wherein the other one of the source electrode and the drain electrode of the turn-on transistor is connected to one end of the light-emitting element, and
wherein the gate electrode of the turn-on transistor is connected to one of the plurality of turn-on control lines.

5. The image display device according to claim 1,
wherein during the light emission period in each of the first drive mode and the second drive mode, the drive circuit supplies a reference voltage to the plurality of signal lines, and
wherein a light emission time of the light-emitting element of each of the plurality of pixels during the light emission period in the first drive mode is longer than a light emission time of the light-emitting element of each of the plurality of pixels during the light emission period in the second drive mode.

6. The image display device according to claim 1, wherein the light emission period in the first drive mode and the light emission period in the second drive mode are adjustable.

7. The image display device according to claim 2, wherein when a clock supplied to the scanning circuit in the second drive mode is clock F, the clock supplied to the scanning circuit in the first drive mode is a clock obtained by combining the clock-F and a clock-f, and
wherein the clock-f is equal in frequency to and different in phase from the clock-F.
